(19) United States
(12) Patent Application Publication
(10) Pub. No.: US 2009/0062159 A1
(43) Pub. Date: Mar. 5, 2009

(54) NON-LUBRICATED COMPONENTS AND MACHINE SYSTEMS AND VEHICLES INCLUDING THE COMPONENTS

(75) Inventors: Don L. Mittendorf, Mesa, AZ (US); Donald J. Christensen, Phoenix, AZ (US); Adam Q. Tejada, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/848,715

(22) Filed: Aug. 31, 2007

(51) Int. Cl. F16C 33/12; F16C 17/00

(52) U.S. Cl. 508/103

(57) ABSTRACT

A non-lubricated component configured to have friction contact with another component and machine systems including the component are provided. In an embodiment, by way of example only, the non-lubricated component includes an outer surface consisting essentially of rhenium having a purity of at least 99%, by weight. The outer surface of the non-lubricated component is capable of being substantially wear- and gall-resistant when contacted by another component at a stress of above 50 ksi.

### TECHNICAL FIELD

The inventive subject matter generally relates to mechanical power-transmitting components, and more particularly relates to non-lubricated mechanical power-transmitting components.

### BACKGROUND

One or more power transmission devices may be implemented into a machine to transmit or share power between one component and another. The power transmission device may include a shaft that is used to couple components within a machine via one or more gears, splines or linkage arrangements. Any suitable machine component capable of operating in response to rotational motion may be coupled to the shaft. In one example, the machine may be part of an aircraft, and may be coupled to a shaft this is driven by a jet engine. In another example, an electromechanical actuator may deliver rotational motion to the shaft, which then selectively deploys or retracts a thrust reverser assembly of the aircraft.

To reduce wear and heat generation during operation of the power transmission device, a lubrication system may be employed. In one type of lubrication system, lubricant, such as oil or grease, is supplied to a housing of a machine within which the gears and shaft may be disposed. The housing may be tightly sealed so that the lubricant does not leak out. However, this configuration can have drawbacks. For instance, in cases in which use of lubricant within the machine may not be practical or may be subjected to an embodiment in which it may decompose, the lubricant may leak out of the housing.

In another type of lubrication system, the gears or shaft may be coated with a self-lubricating material. For example, materials such as paint-based coatings having an added particulate solid such as moly disulfide that can act as a lubricant. Although this type of system may not employ a liquid lubricant that may be susceptible to leaking, it still may have drawbacks. In particular, known self-lubricating materials tend to be limited to low contact stress levels (less than about 10 ksi) and low pressure-velocity capability (e.g., less than about 500,000 psi-ft/min.). In addition, when employed on moving components that operate by friction contact, such as on gears, the components tend to gall or seize when subjected to contact stresses that are greater than 50 ksi or pressure-velocities of greater than 750,000 psi-ft/min. Therefore, use of these known self-lubricating materials may be limited.

Accordingly, there is a need for a system that can operate without lubricants that may be gall-resistant when the components with which it is used are subjected to extreme contract stress environments. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

A non-lubricated component configured to have friction contact with another component is provided. Machine systems and vehicles including the components are also provided.

In an embodiment, by way of example only, the non-lubrication component includes an outer surface consisting essentially of rhenium having a purity of at least 99% by weight. The outer surface of the non-lubrication component is capable of being substantially wear- and gall-resistant when contacted by another component at a stress of above 50 ksi.

In another embodiment, by way of example only, the machine system includes a first component and a second component. The first component includes an outer surface consisting essentially of rhenium having a purity of at least 99%, by weight. The second component is disposed adjacent the first component and is configured to be in friction contact therewith during machine system operation. The second component includes an outer surface consisting essentially of rhenium having a purity of at least 99%, by weight, that is capable of being wear-resistant and gall-resistant when in friction contact with the outer surface of the second component at a stress of above 50 ksi.

In still another embodiment, by way of example only, a vehicle includes a first component, a first non-lubrication component, a second non-lubrication component, and a second component. The first non-lubrication component is coupled to the first component and includes an outer surface consisting essentially of rhenium having a purity of at least 99%, by weight. The second non-lubrication component is disposed adjacent the first non-lubrication component, is configured to be in friction contact therewith during machine system operation, and includes an outer surface consisting essentially of rhenium having a purity of at least 99%, by weight. The second component is coupled to the second non-lubrication component. The outer surface of the first non-lubrication component is capable of being substantially wear-resistant and gall-resistant when in friction contact with the outer surface of the second non-lubrication component at a stress of above 50 ksi.

### BRIEF DESCRIPTION OF THE DRAWINGS

The inventive subject matter will hereinafter be described in conjunction with the following drawing figures, wherein like numerals denote like elements, and

FIG. 1 is a simplified schematic of a machine system, according to an embodiment; and

FIG. 2 is a cross-sectional, close-up view of a portion of a component of a machine system, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

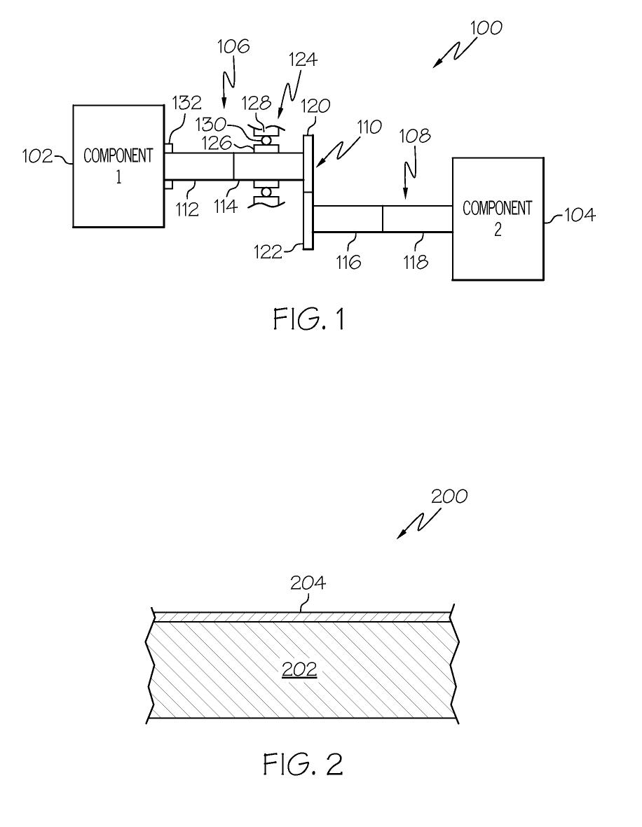

FIG. 1 is a simplified schematic of a machine system 100 according to an embodiment. The machine system 100 may be a power transmission unit and may be implemented into any one of various types of vehicles in which a first component 102 supplies rotational motion that is translated to motion for a second component 104. In an embodiment, the machine system 100 may be implemented into an aircraft. In this regard, the first component 102 may be an air turbine starter, main machine or auxiliary power unit, and the second component 104 may be an aircraft component that receives power from the air turbine starter, main machine or auxiliary power unit. In another embodiment, the first component 102 may be an electromechanical actuator, and the second component 104 may be a thrust reverser component of the aircraft that selectively engages and disengages, in response to the rotation motional supplied by the electromechanical actuator.

In any case, the machine system 100 may include additional components. In an embodiment, the additional components include a first shaft 106, a second shaft 108, and a gear assembly 110. The first shaft 106 is coupled to the first component 102, and the second shaft 108 is coupled to the second component 104. In an embodiment, one or both of the shafts 106, 108 may be made up of two or more splines 112, 114, 116, 118. The first and the second shafts 106, 108 are coupled to each other via the gear assembly 110, which includes at least two meshed gears 120, 122. In an embodiment, additional components may be mounted to one or both of the first or second shafts 106, 108. For example, a bearing assembly 124 may be included that has an inner raceways 126, an outer raceway 128, and a rolling element 130 therebetween. In another example, bushings 132 may be incorporated into the machine system 100. For example, the bushings 132 may be mounted to one or both of the shaft 106, 108 as well.

The machine system 100 may be configured to operate when subjected to extreme contact stress (e.g., at least 50 ksi) and extreme pressure-velocity values (e.g., at least 750,000 psi-ft/min.). To prevent galling and seizing of the shaft splines 112, 114, 116, 118 or gears 120, 122 when subjected to the aforementioned conditions, the shaft splines 112, 114, 116, 118 and/or gears 120, 122 may be configured as non-lubricated components. In this regard, the non-lubricated components may comprise material consisting essentially of substantially pure rhenium. “Pure rhenium” as used herein, may be defined as rhenium having a purity of at least 99%, by weight. In an embodiment, the pure rhenium has a purity of at least 99%, by weight, and may include incidental impurities in trace amounts. In another embodiment, the pure rhenium has a purity of at least 99.99%, by weight. In still another embodiment, the pure rhenium has a purity of 100%, by weight.

In an embodiment, the non-lubricated components have outer surfaces that may be made entirely of material consisting essentially of pure rhenium. In another embodiment, the non-lubricated components may be coated with pure rhenium. For example, a cross-sectional view of a non-lubricated component 200 that may be a shaft spline 112, 114, 116, 118, gear 120, 122, inner raceway 126, outer raceway 128, bearing element 130, or bushing 132 is provided in FIG. 2. The non-lubricated component 200 may include a substrate 202 having a coating 204 formed thereon. The substrate 202 may be any suitable material conventionally used for splines, gears, bearing assembly components, or bushings, such as steel, nickel, cobalt, titanium, or alloys thereof. In another embodiment, the substrate 202 may be rhenium or an alloy thereof.

The coating 204 may comprise a material consisting essentially of substantially pure rhenium. In addition to rhenium, the coating 204 may include incidental impurities in trace amounts. In another embodiment, the coating 204 may comprise material consisting essentially of rhenium having a purity of at least 99.99%, by weight. In still another embodiment, the coating 204 may comprise material consisting essentially of rhenium having a purity of 100%, by weight.

The coating 204 may be deposited on the substrate 202 using any one of numerous deposition processes. For example, the coating may be 204 deposited by chemical vapor deposition, physical vapor deposition, weld deposition, plasma spray, sputtering, or hot isostatic pressure processing of a power pack comprising substantially pure rhenium powder. It will be appreciated that any other suitable deposition processes may alternatively be used. After the coating 204 is deposited on the substrate 202, the component may be machined to a desired shape and/or dimension.

The following example is presented in order to provide a more complete understanding of the non-lubricated components. The specific techniques, conditions, materials, and reported data set forth as illustrations are exemplary, and should not be construed as limiting the scope of the inventive subject matter.

In an example, a plate consisting essentially of substantially pure rhenium (>99%, by weight rhenium) was frictionally contacted with a rectangular pin having a tip with a radius of 0.180 inch. The pin also consisted essentially of pure rhenium. A contact stress of 0 psi was initially applied between the plate and the pin. The contact stress was then increased linearly (e.g., 50 ksi, 100 ksi, 150 ksi, 200 ksi, etc.) to a contact stress of 250 ksi. The test was conducted over 4.7 hours at a constant rubbing rate of 60 feet per minute (“ft/min”) at room temperature. Thus, at initiation, the pressure-velocity value was 60 psi-ft/min and was steadily increased to 15,000,000 psi-ft/min. Both the plate and the pin were found to be substantially gall-resistant and wear-resistant. The term “substantially gall-resistant”, as used herein, may be defined as resistant to a condition wherein contact friction increases substantially (e.g., more than 20%} after two surfaces are rubbed together and localized welding and surface roughing occurs as a result of the contact friction. The term “substantially wear-resistant”, as used herein, may be defined as inhibiting the loss of mass from rubbing surfaces.

Hence, a machine system has been provided that may include non-lubricated components that are substantially gall-resistant and wear-resistant when subjected to contact stresses of at least 50 ksi and up to about 250 ksi. The machine system may be employed in a power transmission unit and its components may operate, without substantial galling or wear when subjected to pressure-velocity values of at least 750,000 psi-ft/min and, in some cases, up to and exceeding 15,000,000 psi-ft/min. Additionally, the machine system may operate without a lubricant or a dedicated housing. As a result, the machine or gearbox assembly system may not be susceptible to leaking lubricant, and may be more lightweight than conventionally lubricated machine or gearbox assembly systems. If a conventionally lubricated system were for some reasons to lose its lubrication the system could continue to operate for a substantial period of time without galling.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A non-lubricated component configured to have friction contact with another component, the non-lubricated component comprising:
an outer surface consisting essentially of rhenium having a purity of at least 99%, by weight,
wherein the outer surface of the non-lubricated component is capable of being substantially wear- and gall-resistant when contacted by another component at a contact stress of above 50 ksi.

2. The non-lubricated component of claim 1, further comprising:
a substrate; and
a coating having the outer surface thereon.

3. The non-lubricated component of claim 2, wherein the substrate comprises a material selected from the group consisting of steel, titanium, nickel, cobalt, and alloys thereof.

4. The non-lubricated component of claim 1, wherein the non-lubricated component comprises a spline.

5. The non-lubricated component of claim 1, wherein the non-lubricated component comprises a gear.

6. The non-lubricated component of claim 1, wherein the non-lubricated component comprises a component of a bearing assembly.

7. The non-lubricated component of claim 1, wherein the non-lubricated component comprises a bushing.

8. The non-lubricated component of claim 1, wherein the outer surface of the non-lubricated component is capable of being substantially wear- and gall-resistant when contacted at a stress of up to 250 ksi.

9. The non-lubrication component of claim 1, wherein the non-lubrication component is substantially gall-resistant when contacted with another component at a pressure-velocity of greater than about 750,000 psi-ft/min.

10. A machine system comprising:
a first non-lubricated component including an outer surface consisting essentially of rhenium having a purity of at least 99%, by weight; and
a second non-lubricated component disposed adjacent the first non-lubricated component and configured to be in friction contact therewith during machine system operation, the second non-lubricated component including an outer surface consisting essentially of rhenium having a purity of at least 99%, by weight,
wherein the outer surface of the first non-lubricated component is capable of being substantially wear-resistant and gall-resistant when in friction contact with the outer surface of the second non-lubricated component at a stress of above 50 ksi.

11. The machine system of claim 10, wherein the first non-lubricated component further comprises:
a substrate; and
a coating including the outer surface thereon.

12. The machine system of claim 11, wherein the substrate comprises a material selected from the group consisting of steel, titanium, nickel, cobalt, and alloys thereof.

13. The machine system of claim 10, wherein:
the first non-lubricated component comprises a first spline; and
the second non-lubricated component comprises a second spline.

14. The machine system of claim 10, wherein:
the first non-lubricated component comprises a first gear; and
the second non-lubricated component comprises a second gear.

15. The machine system of claim 10, wherein:
the first non-lubricated component comprises a bearing element; and
the second non-lubricated component comprises a raceway.

16. The machine system of claim 10, wherein the first non-lubricated component is substantially gall-resistant when contacted with the second non-lubricated component at a pressure-velocity of greater than about 750,000 psi-ft/min.

17. The engine system of claim 10, wherein the outer surface of the first non-lubricated component is capable of being substantially wear- and gall-resistant when contacted with the outer surface of the second non-lubricated component at a stress of above 100 ksi.

18. A vehicle comprising:
a first component;
a first non-lubricated component coupled to the first component including an outer surface consisting essentially of rhenium having a purity of at least 99%, by weight; and
a second non-lubricated component disposed adjacent the first non-lubricated component and configured to be in friction contact therewith during machine system operation, the second non-lubricated component including an outer surface consisting essentially of rhenium having a purity of at least 99%, by weight; and
a second component coupled to the second non-lubricated component,
wherein the outer surface of the first non-lubricated component is capable of being substantially wear-resistant and gall-resistant when in friction contact with the outer surface of the second non-lubricated component at a stress of above 50 ksi.

19. The vehicle of claim 18, wherein the first component comprises a electromechanical actuator and the second component comprises a thrust reverser actuator.
